(19) United States
(12) Patent Application Publication
(10) Pub. No.: US 2026/0105147 A1
(43) Pub. Date: Apr. 16, 2026

(54) SELF-VALIDATING INTEGRATED CIRCUITS

(71) Applicant: HEWLETT PACKARD ENTERPRISE DEVELOPMENT LP, Spring, TX (US)

(72) Inventors: Joseph Wright, Spring, TX (US); Theodore F. Emerson, Spring, TX (US); Nathaniel W. Jansen, Spring, TX (US)

(21) Appl. No.: 18/917,768

(22) Filed: Oct. 16, 2024

(51) Int. Cl. G06F 21/55; H04L 9/32

(52) U.S. Cl. CPC G06F 21/554; H04L 9/3239; G06F 2221/034

(57) ABSTRACT

A technique includes measuring, by a self-validation engine of an integrated circuit, the integrated circuit to provide a hardware integrity measurement. The technique includes generating, by the self-validation engine, an observed fingerprint for the integrated circuit based on the hardware integrity measurement and a firmware integrity measurement. The technique includes validating, by the self-validation engine, the integrated circuit based on the observed fingerprint.

### BACKGROUND

A computer platform may be subject to a security attack for such purposes as seeking access to information that is stored on the computer platform or harming components of the computer platform. To prevent or at least inhibit the degree of potential harm inflicted by security attacks, a computer platform may have different levels of security protection.

### BRIEF DESCRIPTION OF THE DRAWINGS

FIG. 1 is a block diagram of a computer platform having a self-validating silicon root of trust (SRoT) engine according to an example implementation.

FIG. 2 is a block diagram of a secure enclave of a baseboard management controller (BMC) according to an example implementation.

FIGS. 3 and 4 are block diagrams of integrated circuit integrity measurement architectures according to example implementations.

FIGS. 5 and 6 are sequence flow diagrams depicting self-validation processes performed by SRoT engines according to example implementations.

FIG. 7 is a flow diagram of a process to regulate a boot of a computer platform using a self-validating trust anchor, according to an example implementation.

FIG. 8 is a schematic diagram of a computer platform that includes a management controller that has a self-validating hardware-based root of trust engine, according to an example implementation.

FIG. 9 is a schematic diagram of a baseboard management controller that regulates a boot of a computer platform based on a hardware measurement of an integrated circuit that contains an anchor of a chain of trust according to an example implementation.

### DETAILED DESCRIPTION

For purposes of ensuring that a computer platform has not been compromised, the computer platform may be started using a secure, or trusted, boot. A trusted boot begins by a trust anchor (or "root of trust") of the computer platform's chain of trust measuring an initial link (e.g., a set of initial firmware instructions) of the chain of trust to derive an observed measurement (e.g., a hash) and comparing the observed measurement to an expected measurement. If the observed and expected measurements are not the same, then computer platform aborts the boot. If the observed and expected measurements are the same, then the trusted boot proceeds, and the initial link is executed. The initial link, when executed, measures the next link of the chain of trust and compares the observed measurement to an expected measurement, and the trusted boot either proceeds (if the measurements match) or is aborted. This process continues for the trusted boot, as each link of the chain of trust is loaded and executed only if the link is successfully validated by the previously executed link.

A computer platform's trust anchor has traditionally been assumed to be trustworthy. To harden a computer platform against tampering, the computer platform's trust anchor may be a hardware component, such as an integrated circuit (e.g., an application specific integrated circuit (ASIC)). Although a hardware trust anchor is inherently safe from attacks that modify machine-readable instructions, a hardware root of trust may nevertheless be vulnerable to tampering by a sophisticated adversary. As an example of the potential vulnerability of a hardware trust anchor, an attacker may modify a hardware root of trust using focused ion beam (FIB) technology. As another example, a hardware trust anchor may be fabricated in an untrusted geographical location, and an attacker may take advantage of this opportunity to place a spy circuit in the hardware trust anchor.

In accordance with example implementations that are described herein, a hardware trust anchor for a computer platform performs self-validation, and a boot of the computer platform is regulated (e.g., allowed to proceed or aborted) based on a result of the self-validation. More specifically, in accordance with example implementations, the hardware trust anchor acquires a hardware integrity measurement of itself, combines the hardware integrity measurement with a firmware integrity measurement (e.g., a measurement of an initial portion of firmware to be loaded and executed), and generates an observed fingerprint (e.g., a cryptographic hash) based on the hardware integrity measurement and the firmware integrity measurement. The hardware trust anchor compares the observed fingerprint to an expected fingerprint (e.g., an immutable hash stored in one-time-programmable (OTP) fuse memory). If the observed and expected fingerprints match, then the hardware trust anchor passes the self-validation, and otherwise, a mismatch causes the hardware trust anchor to fail the self-validation.

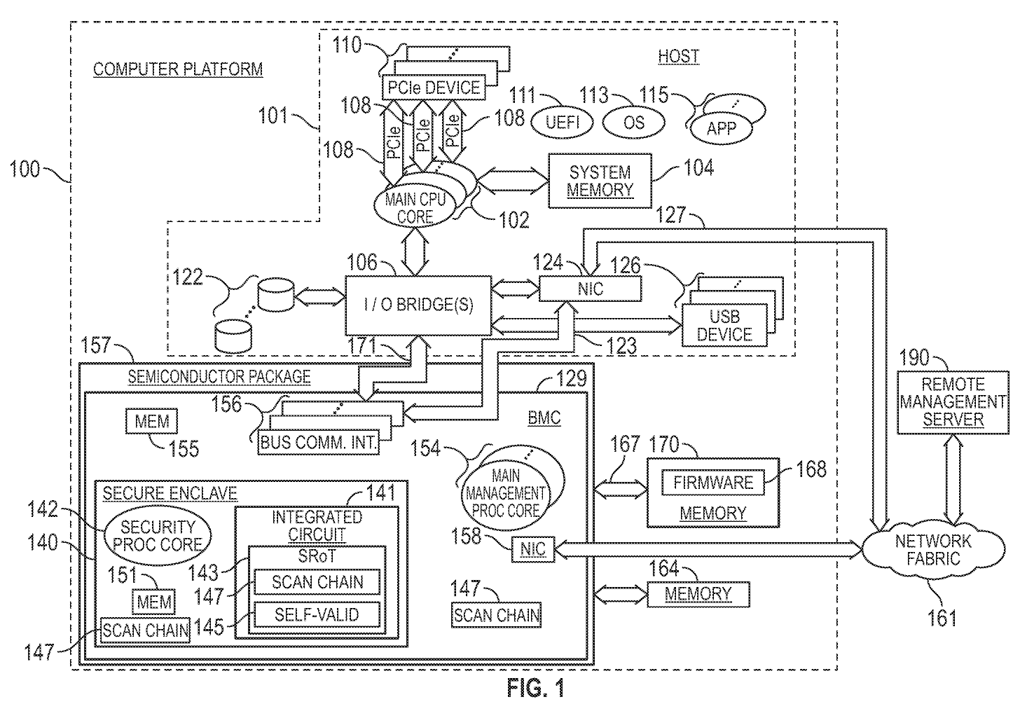

Referring to FIG. 1, as a more specific example, in accordance with some implementations, a computer platform 100 includes a self-validating hardware trust anchor, called a silicon root of trust engine, or "SRoT engine 143" herein. In the context that is used herein, a "hardware trust anchor" refers to a component that corresponds to the beginning, or root, of a chain of trust and does not rely on the execution of machine-readable instructions (e.g., firmware instructions) for its operations.

In an example, the SRoT engine 143 is part of an integrated circuit 141. In this context, an “integrated circuit” refers to an assembly of electronic components that are fabricated on a semiconductor substrate. An integrated circuit corresponds to a semiconductor die. The SRoT engine 143 is part of a semiconductor package 157. Depending on the particular implementation, the semiconductor package 157 may contain one die (corresponding to the integrated circuit 141) or multiple dies (corresponding to the integrated circuit 141 and one or multiple other integrated circuits). The semiconductor package 157 may have one of many different forms. In an example, a semiconductor package 157 may contain one or multiple dies (corresponding to respective integrated circuits) that are mounted on a printed circuit board (PCB) substrate that interconnects the dies. In another example, a semiconductor package 157 may contain multiple dies that are interconnected by bonding wires. In an example, a semiconductor package is encapsulated. In another example, a semiconductor package 157 is not encapsulated. In other examples, a semiconductor package 157 may correspond to any of a number of different containers, such as a surface mount package, a through-hole package, a ball-grid array package, a small outline package or a chip-scale package. Regardless of its particular form, the semiconductor package 157 operatively electrically couples its integrated circuit(s) to a motherboard of the computer platform 100. Although called a "silicon" root of trust engine, the SRoT engine 143 may be fabricated on a semiconductor substrate other than silicon, in accordance with further implementations.

The computer platform 100, in accordance with example implementations, is a modular unit, which includes a frame, or chassis. Moreover, this modular unit may include hardware that is mounted to the chassis and is capable of executing machine-readable instructions. In examples, the computer platform 100 is a server, such as a blade server, a rack server or a tower server. In other examples, the computer platform 100 may be a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

The SRoT engine 143, in accordance with example implementations, includes a self-validation engine 145. As further described herein, the self-validation engine 145, responsive to the integrated circuit 141 receiving power, acquires a hardware integrity measurement of the SRoT engine 143 and acquires an integrity measurement of an initial link of the computer platform's chain of trust. In accordance with example implementations that are described herein, the initial link of the chain of trust corresponds to an initial portion of a firmware image 168 (or "firmware 168") that is stored in a non-volatile memory 170, and the integrity measurement of the initial portion of the firmware 168 is referred to herein as the "firmware integrity measurement." The self-validation engine 145 combines (e.g., concatenates) the hardware integrity measurement and the firmware integrity measurement to form an input value, and the self-validation engine 145 determines an observed fingerprint (e.g., a hash) of the input value. Because the SRoT engine 143 is the trust anchor for the computer platform's chain of trust, the SRoT engine 143 controls whether the initial portion of the firmware 168 is executed based on the observed fingerprint. If the self-validation engine 145 determines that the observed fingerprint matches an immutable reference, or expected, fingerprint, then the SRoT engine 143 allows the initial portion of the firmware 168 to be executed. Allowing the initial portion of the firmware 168 to be executed allows a trusted boot of the computer platform 100 to proceed. If the self-validation engine 145 determines that the observed fingerprint does not match the expected fingerprint, then the SRoT engine 143 does not allow initial portion of the firmware 168 to be executed, and consequentially, prevents a trusted boot of the computer platform 100 from proceeding.

In the context that is used herein, an "integrity measurement" refers to a value that is associated with a hardware or software component of a computer platform and may be used to assess the trustworthiness of the component. In the context that is used herein, a "hardware" integrity measurement refers to a representation of the state or condition of a circuit. In an example, a hardware integrity measurement may be the state of a logic gate of the SRoT engine 143. In another example, a hardware integrity measurement may be the state of a group of related logic gates of the SRoT engine 143. In another example, a hardware integrity measurement may be the state(s) of one or multiple combinatorial logic cones of the SRoT engine 143 responsive to the combinatorial logic cones receiving certain logic inputs. In another example, a hardware integrity measurement may be the state(s) of one or multiple combinatorial logic cones of the SRoT engine 143 responsive to the combinatorial logic cones transitioning through a certain number of states in response to specific inputs. An integrity measurement of firmware, such as the firmware 168, may correspond to a portion of an image or file corresponding to the firmware 168. As part of a trusted boot of the computer platform 100, the firmware 168 may be loaded into memory and executed in stages that correspond to different links of the computer platform's chain of trust.

In accordance with example implementations, the self-validation engine 143 acquires a hardware integrity measurement of the SRoT engine 143 using a built-in testing infrastructure of the SRoT engine 143. More specifically, in accordance with example implementations, the testing infrastructure is an automatic test pattern generation (ATPG) infrastructure, and the integrated circuit 141 includes the ATPG infrastructure. The ATPG infrastructure is a Design for Testability (DFT) feature of the integrated circuit 141. Using an ATPG infrastructure, the manufacturer of the integrated circuit 141 may, during a test mode of operation of the integrated circuit 141, apply input bit vectors corresponding to different stimuli or patterns, to logic of the integrated circuit 141 for purposes of detecting defects or faults if the logic does not respond as expected. For purposes of the SRoT engine's self-validation, the ATPG infrastructure serves an additional purpose of providing one or multiple hardware integrity measurements of the integrated circuit 141.

More specifically, in accordance with example implementations, for purposes of acquiring a hardware integrity measurement, the self-validation engine 145 generates an arrangement, or sequence, of bits, which is called an "input vector" herein. As further described herein, the bits of the input vector correspond to inputs to combinatorial logic cones of the SRoT engine 143 and cause the combinatorial logic cones to collectively provide an arrangement of bits, which is called a "result vector" herein. The result vector corresponds to (e.g., is a component of) a hardware integrity measurement of the integrated circuit.

In accordance with example implementations, the ATPG infrastructure of the SRoT engine 143 includes one or multiple sequential element chains, which are referred to as "scan chains" 147 herein. A scan chain, in general, is a mechanism that allows an input vector to be provided to a circuit (e.g., a collection of combinatorial logic cones) and further allows a response vector, which represents the circuit's response to the input vector, to be received from the circuit.

Depending on the particular implementation, the SRoT engine 143 may include one or multiple scan chains 147. In an example, the self-validation engine 145 operates the scan chain 147 as follows for purposes of acquiring a hardware integrity measurement. First, the self-validation engine 145 places the scan chain 147 in a non-production mode of operation, which is referred to as a "test mode" herein. After placing the scan chain 147 in the test mode, the self-validation engine 145 loads the scan chain 147 with an input vector. As described further herein, the loading of the scan chain 147 with the input vector may include serially shifting in bits of the input vector into sequential elements (e.g., flip-flops) of the scan chain 147. In an example, the bits of the input vector may be pseudorandomly-generated by a deterministic random bit generator of the controller. The self-validation engine 145 next places the scan chain 147 in a production mode of operation, which is referred to as a "mission mode" herein. Upon entering the mission mode, the self-validation engine 145 provides a clock edge to each sequential element of the scan chain 147 for purposes of capturing the result from the combinatorial logic cones. The self-validation engine 145 next once again places the scan chain 147 in the test mode, which allows the captured outputs from the combinatorial logic cones to be unloaded (e.g., serially-shifted out) from the sequential elements of the scan chain 147 to form the corresponding result vector.

The process of loading a scan chain 147 with an input vector, computing and capturing the result, and unloading the result vector from the scan chain 147 may be repeated multiple times to capture different states of the collection of logic cones. Stated differently, a particular hardware integrity measurement may include an aggregation of multiple result vectors from the same scan chain 147. Moreover, in accordance with example implementations, the ATPG infrastructure may include multiple scan chains 147, where each scan chain 147 is associated with a different collection and/or combination of combinatorial logic cones. Accordingly, a given hardware integrity measurement may include result vectors from multiple scan chains 147. In accordance with example implementations, logic simulation modeling may be used to determine an expected hardware integrity measurement, taking into account the different factors that determine the measurement, including the specific combinatorial logic cones, the combinatorial logic cone connections, the connections of the combinatorial logic cones to scan chain(s) 147, the number of scan chain 147 iterations per measurement, the input vector(s), and the input vector(s). Moreover, logic simulation modeling may be used to derive the corresponding expected fingerprint, given the expected hardware integrity measurement and the expected integrity measurement of the initial portion of the firmware 168.

For the example implementation that is depicted in FIG. 1, the computer platform 100 includes a baseboard management controller (BMC) 129, and the SRoT engine 143 is part of a secure enclave 140 of the BMC 129. As depicted in FIG. 1, in accordance with example implementations, the BMC 129 is part of the semiconductor package 157. The BMC 129 includes components that are fabricated on one or multiple semiconductor die of the semiconductor package 157, including the semiconductor die that corresponds to the integrated circuit 141. Although FIG. 1 depicts the integrated circuit 141 as solely containing the SRoT engine 143, other components of the BMC 129 may be fabricated on the integrated circuit 141, in accordance with further implementations. For example, in accordance with further implementations, the semiconductor package 157 contains a single integrated circuit 141, and all components of the BMC 129 are fabricated on this single integrated circuit 141. In another example, the secure enclave 140 (including the SRoT engine 143) is fabricated on an integrated circuit 141 of the semiconductor package 157, and the remaining components of the BMC 129 are fabricated on one or multiple other integrated circuits of the semiconductor package 157. Moreover, in accordance with further implementations, one or multiple components that are depicted outside of the semiconductor package 157 in FIG. 1, such as the non-volatile memory 170, may be part of the semiconductor package 157.

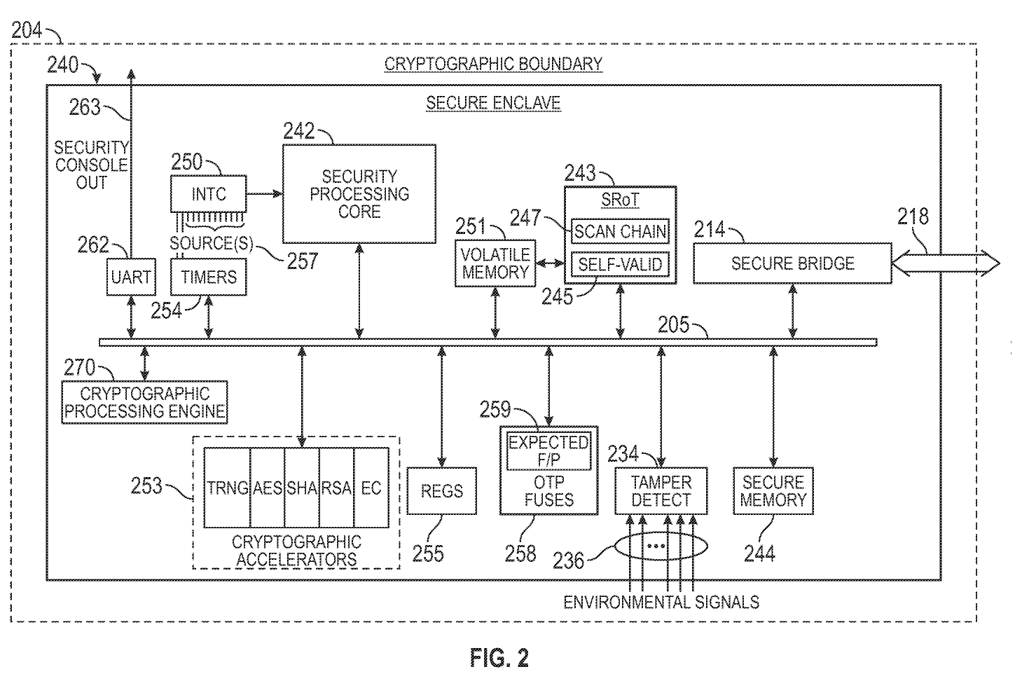

In the context used herein, a "secure enclave" refers to a subsystem, such as a subsystem of the BMC 129, for which access into and out of the subsystem is tightly controlled. A more detailed example architecture for a secure enclave is described below in connection with FIG. 2. Still referring to FIG. 1, in accordance with example implementations, the secure enclave 140 is part of the BMC's security plane and performs cryptographic security-related functions for host(s) 101 of the computer platform 100. In accordance with example implementations, in addition to the SRoT engine 143, the secure enclave 140 includes a security processing core 142 and a volatile memory 151. As described further herein, the SRoT engine 143 is constructed to, when first powered up, hold the security processing core 142 in reset, and the SRoT engine 143 does not release the security processing core 142 from reset until the SRoT engine 143 successfully passes its self-validation. Moreover, as further described herein, in accordance with example implementations, concurrently with the self-validation, the SRoT engine 143 locks the volatile memory 151 from write operations and loads the initial portion of the firmware 168 (which is stored in the non-volatile memory 170) into the volatile memory 151. By locking the volatile memory 151, there is an assurance after successful self-validation that the loaded initial portion of the firmware 168 has not been modified, and consequentially, there is an assurance that the security processing core 142 executes validated firmware.

The secure enclave 140, in accordance with example implementations, is fully disposed inside a cryptographic boundary. A "cryptographic boundary" in this context refers to a continuous boundary, or perimeter, which contains the logical and physical components of a cryptographic subsystem, such as BMC components that form the secure enclave. The secure enclave, in accordance with example implementations, is isolated from the BMC's management plane (and other non-secure components of the BMC 129, which are outside of the secure enclave 140).

The secure enclave 140 is an example of a security processor for the computer platform 100. In the context used herein, a "security processor" refers to a collection of one or multiple components of an electronic device, such as the computer platform 100, which performs one or multiple security-related services for the electronic device. In accordance with further implementations, a self-validating hardware trust anchor, such as the SRoT engine 143, may not be part of a BMC. For example, in accordance with further implementations, self-validating hardware trust anchor may be part of a standalone security-specific semiconductor package that, unlike a BMC, does not perform management services for a host. As another example, in accordance with further implementations, a self-validating hardware trust anchor may be a component of a trusted platform module (TPM). As another example, in accordance with further implementations, a self-validating hardware trust anchor may be a co-processor of a multiple CPU core, CPU semiconductor package (or "socket").

As depicted in FIG. 1, in accordance with some implementations, one or multiple scan chains 147 may be located outside of the SRoT engine 143. In an example, one or multiple scan chains 147 may be located in the secure enclave 140. In another example, one or multiple scan chains 147 may be located in the BMC 129 external to the SRoT engine 143 and external to the secure enclave 140. These additional scan chains 147 test logic cones outside of the SRoT engine 143 so that the hardware integrities of those portions can also be included in the trusted boot chain. Moreover, as described further herein, the hardware integrities of portions distributed across the BMC 129 may also be used for attestation of the computer platform 100.

Among its other features, the BMC 129, in accordance with example implementations, includes a management plane that is isolated from the security plane. In connection with the management plane, the BMC includes one or multiple main management processing cores 154 (called "main management processing cores 154" herein) that execute a set of firmware instructions, called a "firmware management stack," for purposes of performing a variety of management-related functions for host(s) 101 of the computer platform 100. As examples, the BMC 129 provides such management-related functions as operating system runtime services; resource detection and initialization; and pre-operating system services. The management-related functions may also include remote management functions. As examples, the remote management functions include keyboard video mouse (KVM) functions; virtual power functions (e.g., remotely activated functions to remotely set a power state, such as a power conservation state, a power on, a reset state or a power off state); virtual media management functions; and one or multiple other management-related functions for the host(s) 101. In accordance with example implementations, for purposes of performing management services, the BMC 129 may communicate with a remote management server 190 via a NIC 158 of the BMC 129.

In accordance with example implementations, the computer platform 100 has an auxiliary power supply (not shown), which provides auxiliary power for the BMC 129 when AC power is available (e.g., when a power cord for the computer platform 100 is plugged into a power receptacle). The BMC 129, including the secure enclave 140, powers on when the auxiliary power is available. The powering on of the computer platform's host(s) 101 occur later in response to host power request. Whether or not the host(s) 101 boot, depends on the result of the SRoT's self-validation.

More specifically, in accordance with example implementations, when auxiliary power is available, the secure enclave 140 powers up to begin the initial phase of a trusted boot for the computer platform 100. Responsive to receiving the auxiliary power, the SRoT engine 143 holds the BMC's security processing core 142, the BMC's main management processing cores 154 and main CPU cores 102 of the computer platform 100 in reset until the SRoT engine 143 passes its self-validation. In association with the self-validation, the initial portion of the firmware 168 is loaded into the volatile memory 151. Moreover, in accordance with example implementations, the SRoT engine 143 locks the volatile memory 151 to prevent modification or tampering with the initial portion of the firmware 168 as the content is loaded into the volatile memory 151. The SRoT engine 143 passing validation means the following: 1. the content was measured while the content was being loaded into the volatile memory 151; 2. the consolidated measurement of both the content and hardware has been validated against an expected value; and 3. the initial portion of the firmware 168 and the integrated circuit 141 are now trusted. The SRoT engine 143 then releases the security processing core 142 from reset to allow the security processing core 142 to boot and execute the loaded firmware instructions.

By executing the firmware instructions, the security processing core 142 may then validate another portion of the firmware 168 that corresponds to a portion of the BMC's management firmware stack and after successful validation, load this portion of the management firmware stack into a memory 155 of the BMC 129. In accordance with some implementations, the loading of this portion of the management firmware stack may occur concurrently with the validation of the portion. Moreover, after successful validation of this other portion of the firmware 168, the SRoT engine 143 releases the main management processing core(s) 154 from reset. Responsive to being released from reset, the BMC's main management processing core(s) 154 execute the loaded portion of the firmware management stack, which causes the main management processing core(s) 154 to load additional portions of the firmware 168 and place the loaded portions into a memory 164. Access to the memory 164 may involve additional training and initialization steps (e.g., training and initialization steps set forth by the DDR4 specification). Those instructions may be executed from the validated portion of the BMC's firmware management stack in the memory 155.

Therefore, in accordance with example implementations, a cryptographic chain of trust, which is anchored by the SRoT engine 143, may be extended from the SRoT engine 143, the trust anchor, to the firmware management stack that is executed by the BMC's main processing cores 154. Moreover, when a host power request is received, the chain of trust is extended to host system firmware, such as Unified Extensible Firmware Interface (UEFI) firmware 111. In this manner, in accordance with example implementations, the firmware management stack that is executed by the BMC’s main processing core(s) 154 validates host system firmware, such as the UEFI firmware 111. In accordance with example implementations, the UEFI firmware 111 is served through bus fabric from the firmware 168.

In accordance with example implementations, the BMC 129 is constructed to prevent a given domain or entity of the BMC 129 from powering up or coming out of reset until the secure enclave 140 validates the domain/entity. Moreover, in accordance with example implementations, the BMC 129 may prevent components of the BMC 129 from accessing resources of the BMC 129 and resources of the computer platform 100 until the secure enclave 140 approves/validates the resources. The BMC 129 may perform bus filtering and monitoring (e.g., bus filtering and monitoring for a Serial Peripheral Interface (SPI) bus, a system management bus (SMB), an Inter-Integrated Component (I²C) bus, an Improved I²C (I³C) bus, and so forth) to prevent unwanted access to bus devices. For example, the BMC 129 may perform bus filtering and monitoring for a bus 167 (e.g., a SPI bus) that is coupled to a non-volatile memory 170 that stores the firmware 168.

In the context that is used herein, a "host" refers to a collection of components of the computer platform 100, which have an unabstracted view of the resources (e.g., main CPU cores 102, system memory 104, and so forth) of the computer platform 100. Moreover, the host 101 operates under control of an operating system 113 (e.g., a LINUX operating system, a WINDOWS operating system or other operating system) independently of the BMC 129. In accordance with some implementations, the computer platform 100 may contain multiple hosts 101. The BMC 129, in accordance with example implementations, provides management-related services and security-related services for each host 101.

For the example implementation that is depicted in FIG. 1, the resources for a host 101 include one or multiple main CPU cores 102 (e.g., CPU processing cores) and memory devices that are connected to the CPU core(s) 102 to form a system memory 104. The CPU core(s) 102 may be coupled to one or multiple input/output (I/O) bridges 106, which allow communications between the CPU core(s) 102 and the BMC 129, as well as communications with various devices, such as storage drives 122; one or multiple network interface controllers (NICs) 124; one or multiple Universal Serial Bus (USB) devices 126; I/O devices; a video controller; and so forth. As depicted at reference numeral 127, the NIC(s) 124 may be coupled to the network fabric 161. Moreover, as also depicted in FIG. 1, the computer platform 100 may include one or multiple Peripheral Component Interconnect Express (PCIe) devices 110 (e.g., PCIe expansion cards) that may be coupled to the CPU core(s) 102 through corresponding individual PCIe bus(es) 108. In accordance with a further example implementation, the PCIe device(s) 110 may be coupled to the I/O bridge(s) 106, instead of being coupled to the CPU core(s) 102. In accordance with yet further implementations, the I/O bridge(s) 106 and PCIe interfaces may be part of the CPU core(s) 102.

In general, the memory devices that form the system memory 104, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with some implementations, one or multiple NICs 124 may be intelligent input/output peripherals, or "smart I/O peripherals," which may provide backend I/O services for one or multiple applications 115 (or application instances) that execute on the computer platform 100. In accordance with some implementations, one or multiple of the PCIe devices 110 may be smart I/O peripherals. In accordance with example implementations, the computer platform 100 may be connected to a network fabric 161. The network fabric 161 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

In accordance with further implementations, the BMC 129 may communicate with the network fabric 161 via a NIC 124. For example, in accordance with some implementations, via a bus communication interface 156, the BMC 129 may communicate through a sideband bus 123 (e.g., a bus corresponding to a Network Controller Sideband Interface (NC-SI) electrical interface and protocol defined by the Distributed Management Task Force (DMTF)) with the NIC 124.

FIG. 2 depicts a block diagram of an exemplary secure enclave 240 for a BMC (such as the BMC 129 of FIG. 1), in accordance with example implementations. In an example, the secure enclave 240 corresponds to the secure enclave 140 of FIG. 1. Referring to FIG. 2, the secure enclave 240 includes an SRoT engine 243, a security processing core 242, and a volatile memory 251 that correspond to the SRoT engine 143, the security processing core 142 and the volatile memory 151, respectively, of FIG. 1. The SRoT engine 243 includes a self-validation engine 245 and one or multiple scan chains 247, which correspond to the self-validation engine 145 and scan chain(s) 147, respectively, of FIG. 1.

In accordance with example implementations, the secure enclave 240 may be contained within a tightly-controlled cryptographic boundary 204. In general, the components of the secure enclave 240 may communicate using a bus infrastructure 205. In accordance with example implementations, the bus infrastructure 205 may include such features as a data bus, a control bus, an address bus, a system bus, one or multiple buses, one or multiple bridges, and so forth.

The volatile memory 251, in accordance with example implementations, is a static random access memory (SRAM). In accordance with example implementations, the volatile memory 251 stores data representing trusted computing base (TCB) measurements, such as one or multiple PCR banks. The secure enclave 240 includes registers 255. The registers 255 may be software registers, hardware registers, or a combination of hardware and software registers, depending on the particular implementation. For example, in accordance with some implementations, the registers 255 include cryptographically secure registers, such as software platform configuration registers (PCRs). Moreover, in accordance with example implementations, the registers 255 may include operational registers, such as hardware registers that provide control, status and configuration functions for the secure enclave 240. In accordance with some implementations, one or multiple registers 255 may be part of a secure memory 244 of the secure enclave 240. In an example, the secure memory 244 may be a non-volatile RAM (NVRAM).

The secure enclave 240, in accordance with example implementations, includes a secure bridge 214 that, via a secure interconnect 218, controls access to the secure enclave 240 (i.e., establishes a fire wall for the secure enclave 240). As examples, the interconnect 218 may include a bus or an internal interconnect fabric, such as Advanced Microcontroller Bus Architecture (AMBA) Advanced eXtensible Interface (AXI) fabric, or AMBA Advanced High-Performance Bus (AHB) fabric. As an example, in accordance with some implementations, the interconnect 218 may couple to an SPI bus controller that couples one or multiple SPI devices to the secure enclave 240. The secure bridge 214 may provide an additional upstream interface to allow the secure enclave 240 to "reach out" to the interconnect 218. The secure enclave 240 may use the upstream interface to access the firmware (e.g., the firmware 168 of FIG. 1) for purposes of validating the firmware (e.g., providing an initial portion of the firmware to the self-validation engine 145) and loading successfully-validated firmware into the volatile memory 251. The secure bridge 214 may employ filtering and monitoring on the interconnect 218 to prevent unauthorized access to the volatile memory 251 or other components inside the cryptographic boundary 204. In accordance with example implementations, a management plane of a BMC may communicate with the secure enclave 240 via the execution of one or multiple security service application programming interfaces (APIs).

As also depicted in FIG. 2, in accordance with example implementations, the secure enclave 240 may include a tampering detection circuit 234. The tampering detection circuit 234, in accordance with example implementations, receives one or multiple environmental signals 236 (e.g., sensor signals representing a die temperature, a clock rate, a supply voltage magnitude, an enclosure opening status, a removal status, and so forth), which the tampering detection circuit 234 may use to detect tampering. Among its other features, in accordance with some implementations, as depicted in FIG. 2, the secure enclave 240 may include a cryptographic processing engine 270 that encrypts data written to the secure memory 244 and decrypts data read from the secure memory 244. Depending on the particular implementation, the encryption and decryption may use an Advanced Encryption Standard-XOR-Encrypt-XOR-Based Tweaked-Codebook Mode with Ciphertext Stealing (or "AES-XTS") block cipher, or another block cipher. In accordance with further implementations, the encryption and/or decryption may be performed by the security processing core 242.

The secure enclave 240, in accordance with example implementations, may include one or multiple cryptographic accelerators 253, such as symmetric and asymmetric cryptographic accelerators, which assist the security processing core 242 with such operations as key generation, signature validation, encryption, decryption, hashing, and so forth. Moreover, the cryptographic accelerators 253 may include a true random number generator to provide a trusted entropy source for cryptographic operations. In accordance with some implementations, the cryptographic accelerators may include a deterministic random number generator (DRNG). In accordance with some implementations, the self-validation engine 245 may use the cryptographic accelerators 253 for a variety of different purposes, such as applying a cryptographic hash algorithm to an input formed from hardware integrity and firmware integrity measurements and generating pseudorandom numbers for input vectors for the scan chain(s) 247.

In accordance with example implementations, the secure enclave 240 includes a collection of one-time programmable (OTP) fuses 258 (or "OTP fuse memory 258") that store data that represents truly immutable attributes. In accordance with example implementations, the OTP fuses 258 may store data representing an expected fingerprint 259 (e.g., an expected hash) for the SRoT engine 243. The expected fingerprint 259 is an immutable value, which the self-validation engine 245 may compare against an observed fingerprint for purposes of determining whether or not the SRoT engine 243 passes self-validation. In examples, the expected fingerprint 259 is a secure hash algorithm-2 (SHA-2) hash derived by applying a hash algorithm selected from the SHA-2 family of hash algorithms or a secure hash algorithm-3 (SHA-3) hash derived by applying a hash algorithm selected from the SHA-3 family of hash algorithms. The OTP fuses 258 may store immutable attributes other than the expected fingerprint 259. For example, in accordance with some implementations, the OTP fuses 258 may store data that represents a master secret, from which other private keys and secrets for the host(s) 101 and may be derived. As another example, in accordance with some implementations, the OTP fuses 258 may store a unique identifier (e.g., an identifier used to seed a platform identity certificate).

Among its other features, the secure enclave 240 may have other components that, as can be appreciated by one of ordinary skill in the art, may be present in a processor-based architecture, such as a timer 254, an interrupt controller 250 (that receives interrupt triggering stimuli from the timers 254 and other sources), and so forth. Moreover, the secure enclave 240 may contain interfaces to aid in the initial development and debugging of the secure enclave 240 (in the pre-production mode of the secure enclave 240) but may be disabled completely or may have changed functions (for the production mode of the secure enclave 240) when certain fuses (e.g., certain OTP fuses 258) are blown. For example, these interfaces may include one or multiple Universal Asynchronous Receiver/Transmitters (UARTs) 262 that may be used for the debugging and development of the secure enclave 240 and then secured to a transmit only configuration for the production mode of the secure enclave 240. As an example, in accordance with some implementations, a UART 262 may be configured by the OTP fuses 258 to, in the production mode of the secure enclave 240, provide one-way health and status information from the secure enclave 240 in the form of a security console output 263. As another example, in accordance with further implementations, the OTP fuses 258 may disable this UART 262 for the production mode so that all communication with the UART 262 is disabled to prevent all communication across the cryptographic boundary 204. As another example of an interface that may aid in the initial development and debugging of the secure enclave 240 but may be modified/disabled for the production mode, the secure enclave 240 may include a Joint Test Action Group (JTAG) interface (not shown) for the security processor; and this JTAG interface may be disabled for the production mode of the secure enclave 240.

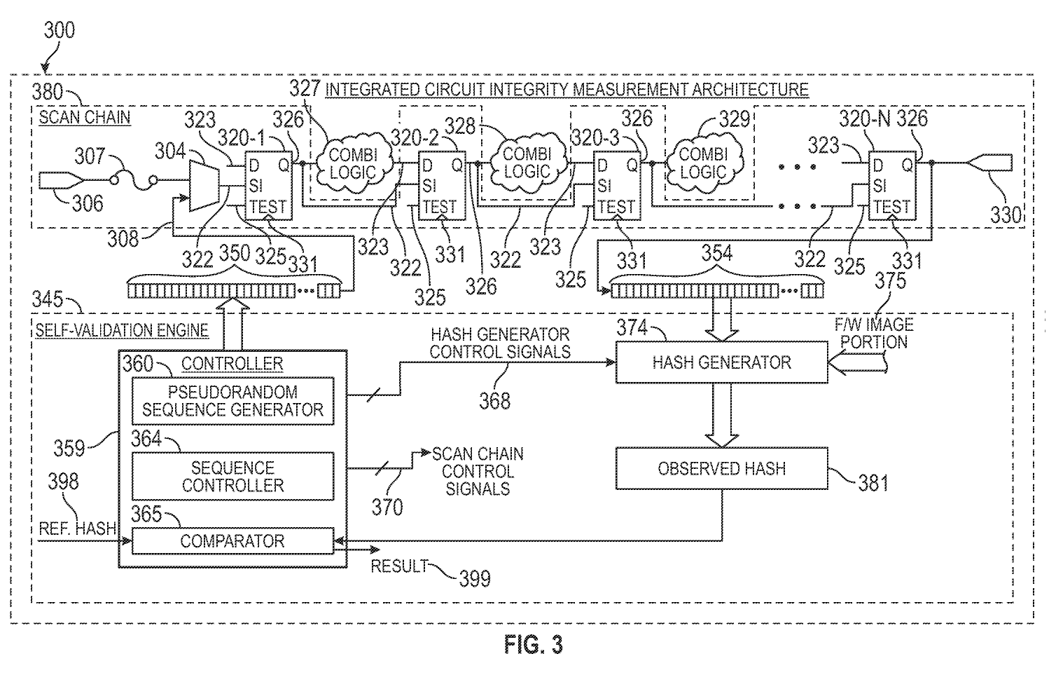

Referring to FIG. 3, in accordance with example implementations, a hardware trust anchor, such as the SRoT engine that is described herein, has an integrated circuit integrity measurement architecture 300 for purposes of performing a self-validation at the beginning of a trusted boot of a computer platform. The trusted boot may be prompted, or triggered, by a power on or reset of a computer platform containing the SRoT. The integrated circuit integrity measurement architecture 300, in accordance with example implementations, is part of an integrated circuit that also includes combinatorial logic (called the "measured combinatorial logic"), such as example combinatorial logic cones 327, 328 and 329. In an example, the combinatorial logic cones 327, 328 and 329 may be associated with one or multiple functions that are performed by the SRoT engine. The combinatorial logic cones are combinatorial logic that is a function of various sequential elements in the design of the SRoT engine. The integrated circuit integrity measurement architecture 300 includes a self-validation engine 345. Depending on the particular implementation, all or a subpart of the combinatorial logic of the SRoT engine may be measured by the self-validation engine 345.

The self-validation engine 345,in accordance with example implementations, includes a controller 359, one or multiple scan chains 380 and a cryptographic hash generator 374. The controller 359 coordinates self-validation-related activities of the SRoT engine, such as activities that cause the scan chain(s) 380 to produce one or multiple result vectors 354, which correspond to a hardware integrity measurement of combinatorial logic. The hash generator 374 applies a cryptographic hash algorithm (e.g., an SHA-2 hash algorithm or an SHA-3 hash algorithm) to an input that is formed from the hardware integrity measurement and a firmware integrity measurement (corresponding to an initial firmware portion 375) for purposes of producing a cryptographic digest, or hash 381, which is referred to as the "observed hash 381." The observed hash 381 corresponds to an expected fingerprint (e.g., the expected fingerprint 259 of FIG. 2) for the SRoT engine. The controller 359 compares the observed hash 381 to a reference, or expected hash 398 (e.g., an immutable fingerprint stored in OTP fuses). Based on a result of the comparison, the controller 359 may then either allow a further boot of the computer platform (e.g., allow the initial firmware portion 375 to be loaded into memory and executed) or prevent the further boot.

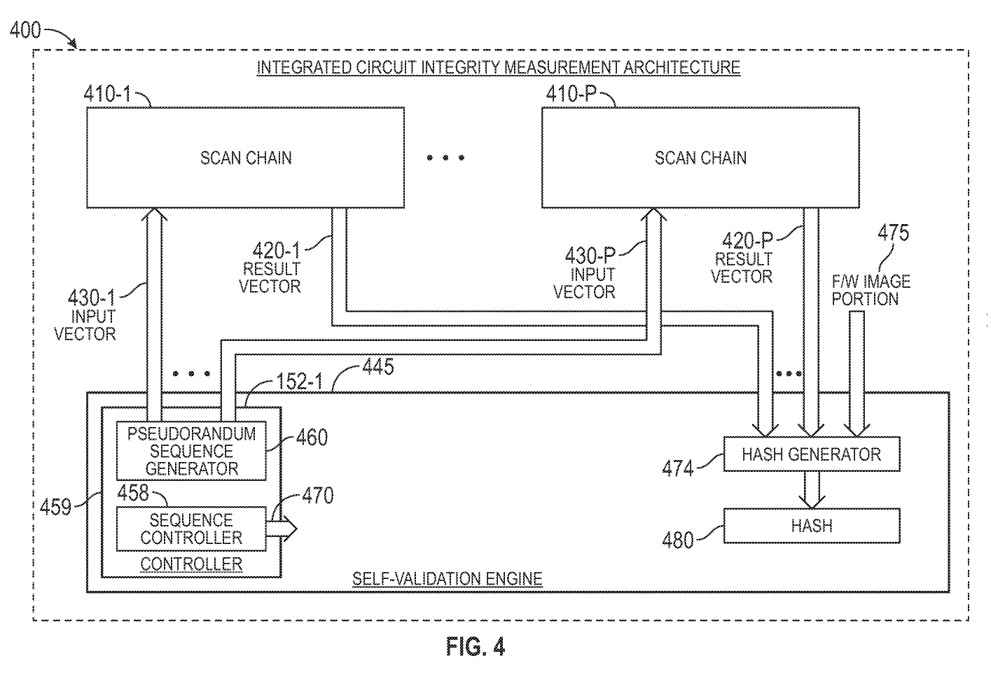

Although FIG. 3 depicts a single scan chain 380, in accordance with further implementations, the integrated circuit integrity measurement architecture 300 may include multiple scan chains 380. In this manner, the self-validation engine 345 may generate input vectors 350 for each of the scan chains 380 and receive respective result vectors from each scan chain. The combination (e.g., concatenation) of the result vectors, in turn, correspond to a particular hardware integrity measurement. The length of the scan chains 380 may vary. For example, each scan chain 380 may be a different length, use a corresponding length-matched input vector 350 and generate a corresponding length-matched result vector 354. An integrated circuit integrity measurement architecture containing multiple scan chains is discussed below in connection with Fig.4.

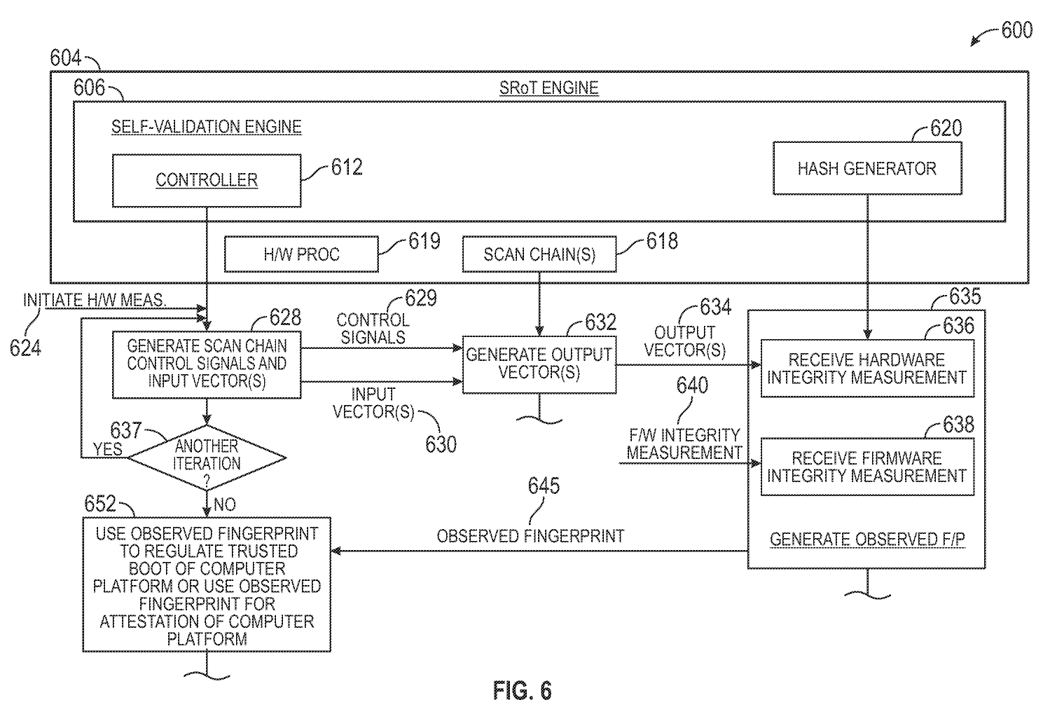

In accordance with further example implementations, the self-validation engine 345 may obtain multiple result vectors 354 from an individual scan chain 380. In an example, the self-validation engine 345 may use multiple sequential phases, or iterations, for the scan chain 380. In an example, the self-validation engine 345 may, for each iteration, load in a different input vector 350 into the scan chain 380 and retrieve, from the scan chain 380, the corresponding result vector 354. An integrated circuit integrity measurement architecture that scans a scan chain in multiple iterations to derive a hardware integrity measurement is discussed below in connection with FIG. 6.

Turning to the specific details, in accordance with example implementations, the scan chain 380 includes a serial chain of N sequential elements, such as N, D-type flip-flops 320. Example D-type flip-flops 320-1, 320-2, 320-3 and 320-N are depicted in FIG. 3. The D-type flip-flop 320 has a signal input that is selectable between an input provided by a D input terminal 323 of the flip-flop 320 and an input provided by a scan insertion (SI) input terminal 322 of the flip-flop 320. The selection of whether the D-type flip-flop 320 is connected to the D input terminal 323 or the SI input terminal 322 is controlled by a mode selection signal that is received at a TEST terminal 325 of the D-type flip-flop 320. In this manner, the logic level of the TEST terminal 325 controls whether the D-type flip-flop 320 is in a production, or mission mode of operation; or whether the D-type flip-flop 320 is alternatively in a test mode of operation.

A sequence controller 364 of the controller 359 provides scan chain control signals 370 for purposes of controlling whether the D-type flip-flops 320 are either all in the mission mode or all in the test mode. More specifically, the selection of the mission mode by the sequence controller 364 causes each D-type flip-flop 320 to receive its input from the D input terminal 323, and the selection of the test mode by the sequence controller 364 causes each D-type flip-flop 320 to receive its input from the SI terminal 322.

The D-type flip-flop 320 is clocked by a clock signal that is received at a clock terminal 331 of the D-type flip-flop 320. In response to a predetermined clocking edge (e.g., a positive going, or leading, edge) of the clock signal, the D-type flip-flop 320 receives and stores the input from the D input terminal 323 (for the mission mode) or the SI input terminal 322 (for the test mode). Moreover, in response to the same predetermined clocking edge of the clock signal, the D-type flip-flop 320 provides its stored value (stored responsive to the predetermined clock edge of the prior clock cycle) to its non-inverting output terminal 326.

As depicted in FIG. 3, the D input terminals 323 of the D-type flip-flops 320-2 to 320-N are connected to respective output terminals of the respective associated combinatorial logic cones. As depicted in FIG. 3, the D input terminals 323 of the D-type flip-flops 320-2 and 320-3 are connected to output terminals of the combinatorial logic cones 327 and 328, respectively. The D input terminal 323 of the first D-type flip-flop 320-1 is unconnected, and the SI input 322 of the first D-type flip-flop 320-1 is connected to the output terminal of a multiplexer 304. The multiplexer 304 selects between an ATPG test path 306 (used for testing of the integrated circuit during manufacturing) and an output of a pseudorandom sequence generator 360 of the self-validation engine 345. In an example, after manufacturing of the integrated circuit integrity measurement architecture 300 is complete, a fuse 307 of the ATPG test path 306 may be blown, and the multiplexer 304 may be permanently configured (e.g., via a fuse or anti-fuse) to permanently select the output of a pseudorandom sequence generator 360 (of the controller 359), which provides an input vector 350. The non-inverting output terminals 326 of the D-type flip-flops 320, except for the last D-type flip-flop 320-N are connected to an input terminal of an associated combinatorial logic cone. As depicted in FIG. 3, the non-inverting output terminals 326 of the D-type flip-flops 320-1, 320-2 and 320-3 are connected to input terminals of the combinatorial logic cones 327, 328 and 329, respectively. The non-inverting output terminal 326 of the D-type flip-flop 320-N is connected to an output terminal 330 of the scan chain 380.

The pseudorandom sequence generator 360 provides a serial sequence of bits, which is referred to herein as an "input vector 350," to the input terminal 308 of the multiplexer 304. Due to the selection configuration of the multiplexer 304, the bits of the input vector 350 are serially-presented to the SI input 322 of the first D-type flip-flop 320-1. When the scan chain 380 is placed in the test mode, the input vector 350 is right bit-shifted into the D-type flip-flops 320-1 to 320-N due to their serial connections. In an example, a bit of the input vector 350 is shifted into the scan chain 380 responsive to each predetermined edge (e.g., a positive going, or rising, edge) of the clock signal, and therefore, an N bit input vector 350 is loaded into the scan chain 380 in N clock cycles. After the input vector 350 is loaded into the scan chain 380, the sequence controller 364 may then change the mode of operation from the test mode to the mission mode. This is done for one clock cycle. The outputs of the logic cones 328 are then captured by the corresponding D-type flip-flops 320. The sequence controller 364 may then change the mode of operation of the serial scan chain 380 from the mission mode to the test mode, and in N clock cycles, the outputs of the D-type flip-flops 320 are shifted from the scan chain 380 to form a sequence of bits called a "result vector 354" herein. Responsive to the mission mode to test mode transition, the scan chain 380 responds to the next predetermined clock edge to provide (from respective D-type flip-flops 320) the bits of the next input vector 350 as inputs to the associated respective combinatorial logic cones and receive (into the respective D-type flip-flops 320) bits corresponding to outputs from the associated respective combinatorial logic cones.

The states of the D-type flip-flops 320 therefore feed into the logic block that is being measured to derive the hardware integrity measurement. The result vector 354 therefore corresponds to a hardware integrity measurement of the SRoT engine. The hash generator 374, in accordance with example implementations, generates the observed hash 381 based on an input value that is derived from one or multiple result vectors 354 and the initial firmware image portion 375.

In accordance with example implementations, the hash generator 374 serially processes the input bits. In this manner, the result vector 354 is fed into the hash generator 374 one bit at a time, and in a similar manner, the firmware image portion 375 is fed into the hash generator 374 one bit at a time. With multiple scan chain 380 iterations and multiple scan chains 380, as further described herein, the hash value produced by the hash generator 374 may be based on the computation of millions of bits. The use of observed and expected hashes therefore greatly reduces the amount of data, which would otherwise be required for validation purposes. Instead of storing gigabytes of expected result vectors or a duplicate copy of the validated portion of firmware, a significantly smaller expected hash (e.g., a 512 bit value) may be stored, which is extremely unlikely to be generated if one or multiple bits of the input to the hash algorithm are incorrect.

The bits of the result vector(s) 354 and the firmware image portion 375 may be fed into the hash generator 374 in any of a number of different orders. In an example, the bits of the firmware image portion 375 are serially fed into the hash generator 374 as the bits are loaded into a memory of the baseboard management controller, and the bits of multiple result vectors 354 are serially fed into the hash generator 374 as the result vectors 354 are generated. In another example, the result vectors 354 are derived and serially fed into the hash generator 374 before the bits of the firmware image portion 375 are loaded into the memory and serially fed into the hash generator 374. In other examples, a serial input stream for the hash generator 374 may be constructed by serially multiplexing bits of the results vectors with bits of the firmware image portion 375 in a certain predefined order. Regardless of how the result vector(s) 354 and the firmware image portion 375 are presented to the hash generator 374, the hash generator 374 has an expected input and an expected output.

In the context that is used herein, a "hash" (which may also be referred to by such terminology as a "digest," "hash value," or "hash digest") is produced by the application of a cryptographic hash algorithm to an input value. Applying a hash algorithm to an input value may also be referred to herein as determining a "hash" of the input value or "hashing" the input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be an SHA-2 hash algorithm, an SHA-3 hash algorithm, a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

In accordance with example implementations, the pseudorandom sequence generator 360 is a deterministic random bit generator (DRBG). In an example, the DRBG may apply a seed to a polynomial function to generate a sequence of bits. In accordance with some implementations, the DRBG may have a design the same or similar to the design described in "Recommendation for Random Number Generation Using Deterministic Random Bit Generators," National Institute of Standards and Technology (NIST) Special Publication 800-90A Rev. 1 (June 2015).

A comparator 365 of the controller 359 compares the observed hash 381 to the reference, or expected hash 398, for purposes of deriving a comparison result 399 that controls whether or not the SRoT engine passes the self-validation. In this manner, a successful self-validation means that the observed hash 381 matches the expected hash 398 (i.e., the hashes are exactly the same), and an unsuccessful, or failed, self-validation means that the observed hash 381 does not match the expected hash 398 (i.e., the hashes are not exactly the same). A successful validation corresponds to neither the hardware of the SRoT engine nor the initial firmware portion 375 being modified. An unsuccessful validation corresponds to one or both of the hardware of the SRoT engine and the initial firmware portion 375 being modified. In an example, the SRoT engine may, in response to the result 399 representing successful self-validation of the SRoT engine, release a hardware processing core (e.g., the security processing core 142 of FIG. 1) from reset and allow the hardware processing core to access the initial firmware portion 375 (e.g., access the initial firmware portion 375 from a locked memory, such as the volatile memory 151 of FIG. 1) and execute the initial firmware portion 375. In an example, the SRoT engine may, in response to the result 399 representing unsuccessful self-validation of the SRoT, maintain the hardware processing core in reset, among initiating other possible remedial actions (notifying a remote management server, powering off the computer platform, quarantining the computer platform from a network, or other measures).

In accordance with example implementations, a particular combinatorial logic cone (e.g., the combinatorial logic cone 327, 328, 329 or another combinatorial logic cone) may include one or multiple logic gates. As examples, a logic gate may be a combinatorial logic gate, such as an AND gate, an OR gate, a NAND gate, a NOT gate, a NOR gates, an XOR gate, or, in general, a device that applies a Boolean algebra expression to one or multiple Boolean input to provide a Boolean output in accordance with the Boolean algebra expression. The logic gates of a logic cone 328 may be arranged to form any of a number of logic elements, such as a register, a counter, a timer, a delay circuit, a comparison circuits, a circuit to implement a state of a state machine, or in general, a set of logic gates that perform a certain function. In an example, the function may be a function performed for a hardware trust anchor, such as the SRoT engine that is described herein.

A pseudorandom input vector 350 has a certain probability of exercising a portion of that logic cone which is captured at the destination D-type flip-flop 320 and measured by means of the result vector 354. As more and more input vectors 350 are sequenced through the logic, the probability that certain elements in the logic cone are measured increases. As part of the DRNG, simulation may be used to determine not just the expected result but also establish a predetermined iteration number that produces a certain coverage measurement. For example, through simulation, it may be determined that 8000 DNRG-derived input vectors 350 achieve an 85% average coverage of the logic cones. The number of iterations may therefore be selected based on a desired coverage level. The more iterations, the greater the coverage but the longer time for performing the validation.

Referring to FIG. 4, an integrated circuit integrity measurement architecture 400 includes a self-validation engine 445 and P scan chains 410 (example scan chains 410-1 and 410-P being depicted in FIG. 4). The combinatorial logic cones that are connected to the scan chains 410 are not depicted in FIG. 4. The self-validation engine 445 includes a controller 459 that includes a pseudorandom sequence generator 460 and a sequence controller 458. The pseudorandom sequence generator 460 is constructed to provide P input vectors 430 (example input vectors 430-1 and 430-P being depicted in FIG. 4) to respective scan chains 410. Depending on the particular implementation, the input vectors 430-1 to 430-P may be the same or different.

The sequence controller 458, via control signals 470, regulates whether one or multiple scan chains 410 are in the mission mode or test mode for purposes of acquiring a hardware integrity measurement that corresponds to a combination (e.g., a concatenation or other combination) of the result vectors 420-1 to 420-P. In accordance with example implementations, the sequence controller 458 concurrently places all of the scan chains 410 in the test mode for purposes of loading the input vectors 430 (generated by the pseudorandom sequence generator 460) into their respective associated scan chains 410. Next, the sequence controller 458 concurrently places all of the scan chains 410 in the mission mode for purposes of allowing the scan chains 410 to capture outputs of their respective associated combinatorial logic cones. Next, the sequence controller 458 concurrently places all of the scan chains 410 in the test mode for purposes of unloading the scan chains 410 and therefore, providing the result vectors 420-1 to 420-P. Subsequently, the sequence controller 458 may return the scan chains 410 to the mission mode.

The result vectors 420-1 to 420-P and an initial firmware portion 475 provide an input value for the hash generator 474. The result vectors 420-1 to 420-P and initial firmware portion 475 may combined in any of a number of different ways to derive the input value. The hash generator 474 applies a cryptographic hash algorithm to the input value for purposes of deriving an observed hash 480. The controller 459 may then process the observed hash 480, such as the processing described herein for the controller 359 of FIG. 3.

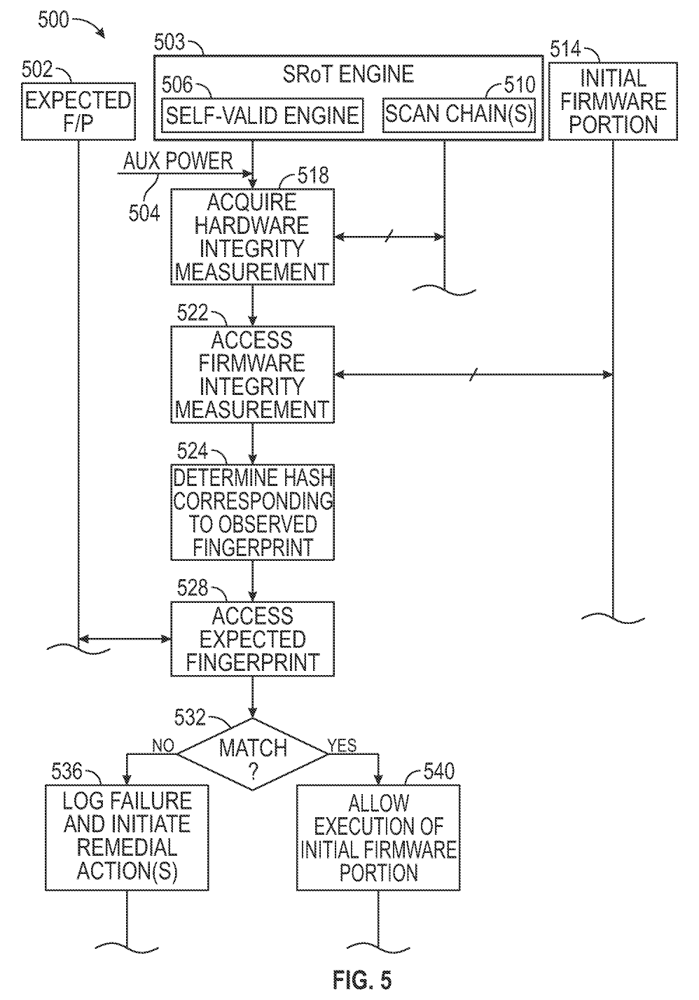

FIG. 5 is a sequence flow diagram 500 depicting a process to validate an SRoT engine 503 according to an example implementation. Referring to FIG. 5, the SRoT engine 503 includes a self-validation engine 506 and one or multiple scan chains 510. In an example, the sequence 500 is initiated in response to auxiliary power becoming available to power up the SRoT engine 503, as depicted at 504. In other examples, the sequence 500 may be initiated in response to a particular power rail of a main power becoming available or in response to another power domain becoming available. In another example, the sequence 500 may be initiated in response to a reset of the computer platform. The sequence 500 includes the self-validation engine 506 determining, as depicted at 518, a hardware integrity measurement. In accordance with example implementations, determining the hardware integrity measurement includes the self-validation engine 506 using the scan chain(s) 510 to determining various combinatorial logic cone states responsive to one or multiple input vectors. Depending on the particular implementation, the hardware integrity measurement may correspond to multiple scans of a particular scan chain 510 and/or the aggregation of result vectors from multiple scan chains 510.

In accordance with example implementations, the self-validation engine 506 determines a firmware integrity measurement, pursuant to block 522. As depicted in FIG. 5, in accordance with example implementations, for this purpose, the firmware integrity measurement may correspond to an initial firmware portion 514.

As depicted at 524, pursuant to the sequence 500, the self-validation engine 506 may then determine a hash that corresponds to the observed fingerprint (e.g., a hash) for the SRoT engine 503. In accordance with some implementations, determining the observed fingerprint includes the self-validation engine 506 applying a cryptographic hash algorithm to an input value that is derived from the hardware integrity measurement and the firmware integrity measurement for purposes of generating the observed fingerprint. Next, the self-validation engine 506 accesses an expected fingerprint 502 for the SRoT engine 503, as depicted at 528. In an example, accessing the expected fingerprint may include the self-validation engine 506 accessing an immutable sequence of bits representing the expected fingerprint. In an example, accessing the expected fingerprint may include the self-validation engine 506 determining the status of a collection of OTP fuses. .

The self-validation engine 506 determines, as depicted at decision block 532, whether the observed fingerprint matches the expected fingerprint. If so, then the self-validation engine 506 allows the execution of the initial firmware portion 514, as depicted at 540. Allowing the execution of the initial firmware portion 514 may include a number of actions, such as allowing the initial firmware portion 514 to be loaded into memory and releasing a hardware processing core from reset to allow the hardware processing core to execute, from the memory, the loaded initial firmware portion 514. Otherwise, if the observed and expected fingerprints do not match, then the self-validation engine 506 logs the failure and initiates one or multiple remedial actions, as depicted at 536. In an example, the remedial action(s) may include maintaining a hardware processing core in reset, preventing the booting of the computer platform, alerting a remote management server, sending a message to a system administrator, quarantining the computer platform from a network, as well as one or multiple and/or different actions.

FIG. 6 is a sequence flow diagram 600 depicting a process to validate an SRoT engine 604 according to a further example implementation. The SRoT engine 604 includes a self-validation engine 606, one or multiple scan chains 618 and a hardware processor 619. In response to a boot of a computer platform containing the SRoT engine 604, the SRoT engine 604 holds the hardware processor 619 in reset, pending the results of the validation by the self-validation engine 606. The self-validation engine 606 includes a controller 612 and a hash generator 620. The controller 612 validates the SRoT engine 604 based on a hardware integrity measurement derived from the scan chain(s) 618 and a firmware integrity measurement 640 corresponding to an initial firmware portion to be executed by the hardware processor 619 if the SRoT engine 604 passes the self-validation. For this example implementation, the scan chain(s) 618 undergo multiple phases, or iterations (called "scan chain iterations" herein), for purposes of generating the hardware integrity measurement. Each scan chain iteration corresponds to the scan chain(s) 618 producing a different set of result vector(s) 634 (e.g., one result vector 634 per iteration if one scan chain 618 and multiple result vectors 634 per iteration if multiple scan chains 618).

The process to validate the SRoT engine 604 begins with an initiation 624 of the hardware integrity measurement. In an example, the SRoT engine 604 is part of a BMC, the BMC is part of a computer platform that has a primary power supply and the initiation 624 corresponds to the BMC receiving auxiliary power before the other components of the computer platform receive primary power from the primary power supply. As depicted at 628, in the initial scan chain iteration, the controller 612 generates scan chain control signals 629 and one or multiple input vectors 630 (depending on the number of scan chains 618), which are provided to the scan chain(s) 618. As depicted at 632, in response to the control signals 629 and the input vector(s) 630, the scan chain(s) 618 generate the corresponding result vector(s) 634.

As depicted at 635, the hash generator 620 generates an observed fingerprint 645. For this purpose, the hash generator 620 applies a cryptographic hash algorithm to an input that includes one or multiple result vector(s) 634. As depicted at 636, the hash generator 620 receives the result vector(s) 634 (e.g., serially receives and processes the bits of the result vector(s) as the result vector(s) 634 become available). Moreover, the input to the hash generator 620 includes a firmware integrity measurement 640. As depicted at 638, the hash generator 620 receives the firmware measurement (e.g., serially receives and processes the bits of the firmware integrity measurement 640. In an example, the hash generator 620 receives and processes the bits of the firmware integrity measurement 640 as the bits are loaded into a memory by the controller 612, and the memory is locked after the bits corresponding to the firmware integrity measurement 640 are loaded. As depicted at decision block 637, the controller 612 determines whether to perform another scan chain iteration, and if so, control returns to block 628.

The hash generator, as a result of applying a cryptographic hash algorithm to the input that includes the result vector(s) 634 and the firmware integrity measurement 640, produces the observed fingerprint 645. The observed fingerprint 645 may be used in a number of different ways, depending on the particular implementation. As depicted at block 652, the controller 612 may use the observed fingerprint 645 to regulate a trusted boot of a computer platform or use the observed fingerprint for attestation purposes.

More specifically, in accordance with example implementations, the controller 612 may, as described herein, compare the observed fingerprint 645 to an expected fingerprint, and control a trusted boot of the computer platform based on whether or not the fingerprints match. In accordance with further implementations, the computer platform is allowed to boot, without making a determination of whether or not the observed fingerprint 645 is expected. Instead, the observed fingerprint 645, for this use case, corresponds to an integrity measurement that is verified by a remote verifier for purposes of the remote verifier determining whether or not the computer platform is to be trusted.

In an example, when used for purposes of attestation, the observed fingerprint 645 is the initial integrity measurement for a measured boot of the computer platform and corresponds to an initial state of a measurement digest for the computer platform. As part of the measured boot, the firmware corresponding to the measurement 640 measures the next link of the computer platform's chain of trust and extends the measurement digest based on this measurement. The process continues for the measured boot, as each link of the chain of trust measures the next link of the chain of trust and extends the measurement digest based on this measurement, culminating with the measurement digest being finally extended with the measurement of the operating system boot loader. Neither the measurement digest, in any of its states, nor the integrity measurement are evaluated during the measured boot. The final measurement digest produced at the culmination of the measured boot may then be communicated (e.g., sent by the computer platform as a PCR quote in response to a PCR quote request) to a remote verifier that determines whether the computer platform is trustworthy by comparing the computer platform's measurement digest to an expected measurement digest for the computer platform. As can be appreciated, when used in this manner, the computer platform boots regardless of the observed fingerprint 645, but if the observed fingerprint 645 has a value that varies from its expected value, then the computer platform fails attestation. Any of a number of remedial actions may result from a computer platform failing attestation, such as the computer platform not being able to join a network or not being able to connect to a resource in a data center.

Other variations are contemplated, which are within the scope of the appended claims. For example, in accordance with further implementations, the trust anchor may be part of a management controller other than a baseboard management controller, such as a smart I/O peripheral (e.g., a PCIe or CXL card) that performs management and security services for the computer platform. Depending on the particular implementation, the self-validation engine may not be measured by any of the scan chains, or the self-validation engine may be measured by one or multiple scan chains. As can be appreciated, in accordance with example implementations, some of the logic inside the self-validation engine may be excluded from the hardware integrity measurement as leveraging the ATPG infrastructure around those flip-flops may lead to a disturbance in the flip-flop states included in the self-validation engine.

In the context that is used herein, a BMC is a specialized service processor that monitors the physical state of a server or other hardware using sensors and communicates with a management system through a management network. The BMC may also communicate with applications executing at the operating system level through an input/output controller (IOCTL) interface driver, a representational state transfer (REST) application program interface (API), or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

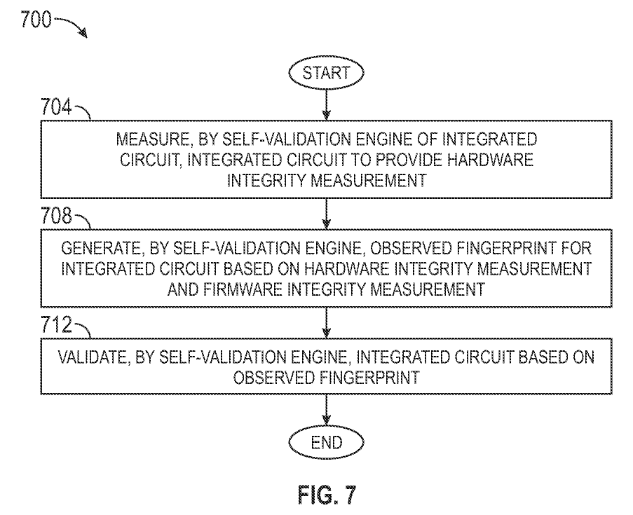

Referring to FIG. 7, in accordance with example implementations, a technique 700 includes measuring (block 704), by a self-validation engine of an integrated circuit, the integrated circuit to provide a hardware integrity measurement. In an example, the self-validation engine is part of a trust anchor of a computer platform. In an example, the computer platform is a server. In an example, the trust anchor corresponds to a security processor of the computer platform. In an example, the trust anchor is a hardware component of a baseboard management controller of the computer platform. In an example, the trust anchor is part of a secure enclave that is inside a cryptographic boundary. In an example, the secure enclave is part of a baseboard management controller. In examples, the trust anchor may be a standalone security component of the computer platform or a TPM.

In an example, the trust anchor includes one or multiple scan chains and a self-validation engine. The self-validation engine is constructed to operate the scan chain(s) to measure one or multiple combinatorial logic cones of the trust anchor. In an example, the scan chain(s) may be part of an ATPG infrastructure of the integrated circuit. In an example, the self-validation engine includes a pseudorandom sequence generator, such as a DRNG, to generate one or multiple input vectors for the scan chain(s). In an example, the trust anchor includes a single scan chain that provides a result vector that represents the hardware integrity measurement. In another example, the trust anchor includes multiple scan chains that provide respective result vectors that collectively represent the hardware integrity measurement. In an example, the self-validation engine operates a scan chain in multiple scan chain phases, or iterations, to produce multiple result vectors that are part of the hardware integrity measurement.

The technique 700 includes, pursuant to block 708, generating, by the self-validation engine, an observed fingerprint for the integrated circuit based on the hardware integrity measurement and a firmware integrity measurement. In an example, a firmware image is loaded and executed in stages in the computer platform, and the firmware integrity measurement corresponds to an initial portion of the firmware image. In an example, the initial portion of the firmware image corresponds to an initial link of a chain of trust for the computer platform, and the trust anchor is fabricated in an integrated circuit.

The technique 700 includes validating (block 712), by the self-validation engine, the integrated circuit based on the observed fingerprint. In an example, validating the integrated circuit includes determining an input value based on the initial portion of the firmware image and the hardware integrity measurement, and applying a cryptographic hash algorithm to the input value to derive an observed hash. In an example, determining the input value includes concatenating the initial portion of the firmware image and the hardware integrity measurement. In an example, applying the cryptographic hash algorithm includes applying an SHA, SHA-2, SHA-3, an FIPS-approved algorithm or an NIST-approved algorithm. In an example, validating the integrated circuit includes comparing the observed hash to an expected hash for the integrated circuit. In an example, the expected hash is immutable. In an example, the expected hash is represented by the status of a collection of OTP fuses.

In an example, a security processing core of a baseboard management controller of the computer platform is configured to execute the initial portion of the firmware image from a memory of the baseboard management controller, if the trust anchor is successfully validated. In an example, the trust anchor is constructed to hold the security processing core in reset pending validation of the trust anchor, and the trust anchor is constructed to release the security processing core from reset responsive to successful validation of the trust anchor. In an example, the technique 700 is initiated in response to power (e.g., auxiliary power) being provided to the baseboard management controller.

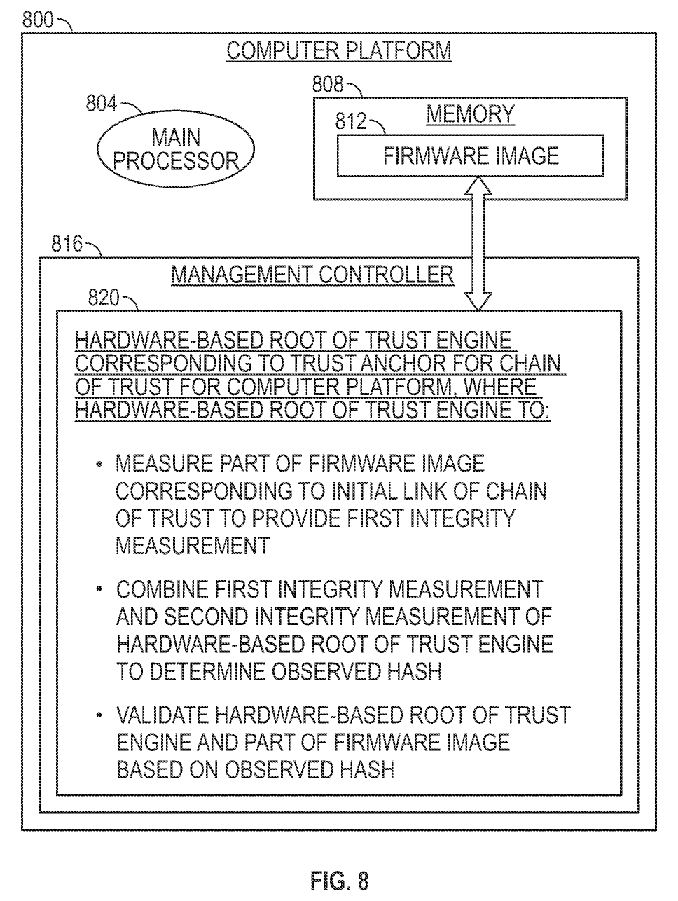

Referring to FIG. 8, in accordance with example implementations, a computer platform 800 includes a main processor 804, a memory 808 and a management controller 816. The memory stores a firmware image 812. In an example, the computer platform 800 is a modular unit, which includes a frame, or chassis, and the modular unit may include hardware that is mounted to the chassis and is capable of executing machine-readable instructions. In examples, the computer platform 800 is a server, such as a blade server, a rack server or a tower server. In other examples, the computer platform 800 may be a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the management controller 816 is a baseboard management controller. In another example, the management controller 816 is a smart I/O peripheral.

The management controller 816 includes a hardware-based root of trust engine 820. The hardware-based root of trust engine 820 corresponds to a trust anchor for a chain of trust for the computer platform 800. The hardware-based root of trust engine 820 measures a part of the firmware image corresponding to an initial link of the chain of trust to provide a first integrity measurement. In an example, the hardware-based root of trust engine 820 is a hardware component of a baseboard management controller of the computer platform. In examples, the hardware-based root of trust engine 820 may be standalone security component of the computer platform or a TPM. In an example, the trust anchor is constructed to hold the security processing core in reset pending validation of the trust anchor, and the trust anchor is constructed to release the security processing core from reset responsive to successful validation of the trust anchor. In an example, the part of the firmware image is loaded into a memory of the management controller 816 as the first integrity measurement is being measured, and the memory is locked to prevent modification of content that is loaded into the memory. In an example, a security processing core of the secure enclave is released from reset and allowed to execute the part of the firmware image responsive to the hardware-based root of trust engine 820 being successfully validated.

The hardware-based root of trust engine 820 combines the first integrity measurement and a second integrity measurement of the hardware-based root of trust engine to determine an observed integrity measurement. In an example, the trust anchor includes one or multiple scan chains. The trust anchor operates the scan chain(s) to measure one or multiple combinatorial logic cones of the trust anchor. In an example, the combinatorial logic cones may correspond to functions of the trust anchor. In an example, the scan chain(s) may be part of an ATPG infrastructure of the integrated circuit. In an example, combining the first integrity measurement and the second integrity measurement includes concatenating the measurements. In an example, determining the observed integrity measurement includes applying a cryptographic hash algorithm to an input derived from the first integrity measurement and the second integrity measurement.

The hardware-based root of trust engine 820 validates the management controller 816 and the part of the firmware image 812 based on the observed integrity measurement. In an example, the validation includes comparing the observed integrity measurement to an expected integrity measurement. In example, the validation includes comparing an observed hash to an expected hash. In an example, the validating includes determining an expected integrity measurement. In an example, determining an expected integrity measurement includes accessing an immutable value stored in the computer platform 800. In an example, determining an expected integrity measurement includes accessing an immutable value stored in an OTP fuse memory of a secure enclave of the management controller 816.

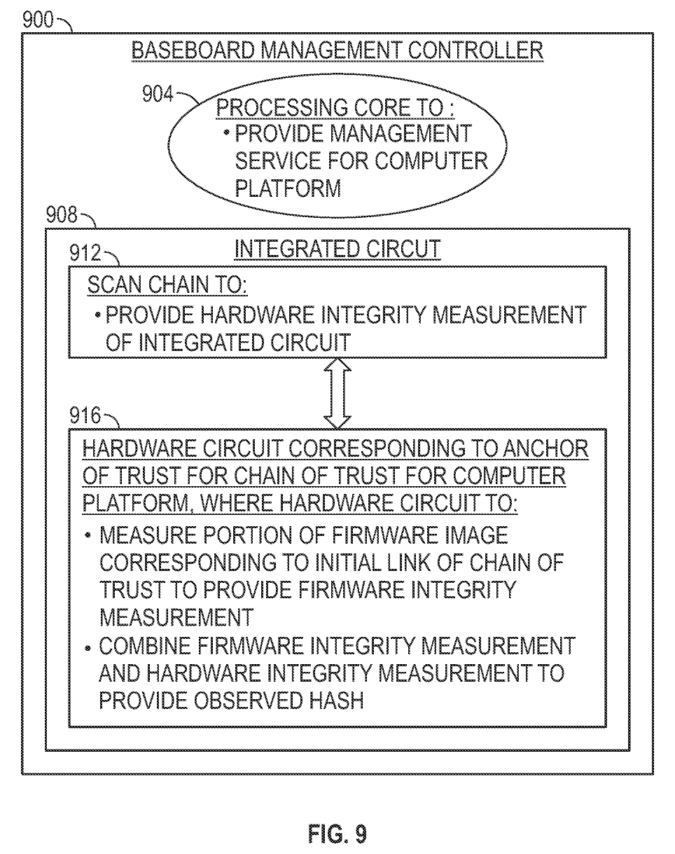

Referring to FIG. 9, in accordance with example implementations, a baseboard management controller 900 includes a processing core 904 and an integrated circuit 908. The processing core 904 provides a management service for a computer platform. In an example, the processing core 904 is a main management processing core for the baseboard management controller 900. In an example, the management service may be related to a KVM function, a virtual power function, or a virtual media management function.

The integrated circuit 908 includes a scan chain 912 and a hardware circuit 916 that corresponds to an anchor of trust for a chain of trust for the computer platform. The scan chain 912 provides a hardware measurement of the integrated circuit 908. In an example, the integrated circuit 908 is a silicon root of trust engine. In an example, the integrated circuit 908 is part of a secure enclave of the baseboard management controller 900. In an example, the integrated circuit 908 holds a security processing core of the baseboard management controller 900 in reset until the anchor of trust is validated. In an example, the scan chain 912 may be a DFT feature of the integrated circuit 908. In an example, the scan chain 912 is included in the integrated circuit 908 for purposes of allowing pre-production testing of the integrated circuit 908. In an example, the scan chain 912 is part of an ATPG testing infrastructure. In an example, the scan chain 912 is associated with a fuse to disable an input corresponding to pre-production testing of the integrated circuit 908. In an example, the scan chain 912 includes a serial chain of sequential elements. In an example, the scan chain 912 includes a serial chain of D-type flip-flops. In an example, the D-type flip-flop has two input terminals. In an example, one input terminal of the D-type flip-flop is a scan insertion input terminal associated with a testing mode of operation of the D-type flip-flop, and another input terminal of the D-type flip-flop is a noninverting signal input associated with a mission mode of operation of the D-type flip-flop.

The hardware circuit 916 measures a portion of a firmware image that corresponds to an initial link of chain of trust to provide a firmware integrity measurement. The hardware circuit 916 combines the firmware integrity measurement and the hardware integrity measurement to provide an observed hash. The hardware circuit 916 regulates a boot of the computer platform based on a comparison of an expected hash to the observed hash. In an example, the boot is a trusted boot of the computer platform. In an example, the hardware circuit 916 performs a self-validation based on the comparison of the expected hash to the observed hash. In an example, the hardware circuit 916 holds a security processing core of the baseboard management controller 900 in reset and releases the security processing core from reset responsive to the observed hash matching the expected hash. In an example, the hardware circuit 916 measures the portion of the firmware image as the portion of the firmware image is loaded into a memory of the baseboard management controller 900. In an example, the memory is locked so that content corresponding to the portion of the firmware image cannot be modified after the content is loaded into the memory. In an example, the release of the security processing core from reset allows the security processing core to access the portion of the firmware image from the memory and execute the portion of the firmware image.

In accordance with example implementations, the self-validation engine is a trust anchor of a computer platform, and the firmware integrity measurement is an initial portion of a firmware image. The initial portion of the firmware image corresponds to an initial link of a chain of trust for the computer platform. Among the potential benefits, rather than assuming that a hardware trust anchor has not been compromised, the hardware trust anchor performs self-validation to prove that the trust anchor is trustworthy.

In accordance with example implementations, a boot of the computer platform is regulated responsive to a result of the validation. Among the potential benefits, rather than assuming that a hardware trust anchor has not been compromised, the hardware trust anchor performs self-validation to prove that the trust anchor is trustworthy.

In accordance with example implementations, the observed fingerprint is an observed hash. Generating the observed fingerprint includes applying, by the self-validation engine, a cryptographic hash algorithm to an input to provide the observed hash. The input includes the hardware integrity measurement and the firmware integrity measurement. Validating the integrated circuit includes comparing, by the self-validation engine, the observed hash to an expected hash. Among the potential benefits, rather than assuming that an integrated circuit has not been compromised, the integrated circuit performs self-validation to prove that the integrated circuit is trustworthy.

In accordance with example implementations, measuring the integrated circuit includes measuring combinatorial logic of the integrated circuit. Among the potential benefits, rather than assuming that an integrated circuit has not been compromised, the integrated circuit performs self-validation to prove that the integrated circuit is trustworthy.

In accordance with example implementations, measuring the combinatorial logic includes providing a first input vector of bits to combinatorial logic cones of the integrated circuit. Measuring the combinatorial logic further includes, responsive to providing the first input vector of bits to the combinatorial logic cones, receiving a first result vector of bits corresponding to the hardware integrity measurement from the combinatorial logic cones. Among the potential benefits, rather than assuming that an integrated circuit has not been compromised, the integrated circuit performs self-validation to prove that the integrated circuit is trustworthy.

In accordance with example implementations, measuring the combinatorial logic further includes providing a second input vector of bits to the combinatorial logic cones. Measuring the combinatorial logic further includes, responsive to providing the second input vector of bits to the combinatorial logic cones, receiving a second result vector of bits from the combinatorial logic cones, and combining the first result vector of bits and the second result vector of bits to provide the hardware integrity measurement. Among the potential benefits, rather than assuming that an integrated circuit has not been compromised, the integrated circuit performs self-validation to prove that the integrated circuit is trustworthy.

In accordance with example implementations, the combinatorial logic cones are connected to a chain of sequential elements. Providing the first input vector of bits to the combinatorial logic cones includes placing the chain of sequential elements in a test mode of operation, and responsive to placing the chain of sequential elements in the test mode of operation, loading the bits of the first input vector of bits into the chain of sequential elements. Among the potential benefits, rather than assuming that an integrated circuit has not been compromised, the integrated circuit performs self-validation to prove that the integrated circuit is trustworthy.

In accordance with example implementations, the chain of sequential elements is transitioned from the test mode of operation to a production mode of operation to cause the chain of sequential elements to capture a response of the combinatorial logic cones to the first input vector of bits. Among the potential benefits, rather than assuming that an integrated circuit has not been compromised, the integrated circuit performs self-validation to prove that the integrated circuit is trustworthy.

In accordance with example implementations, receiving the first result vector of bits includes transitioning the chain of sequential elements from the production mode of operation to the test mode of operation, and responsive to placing the chain of sequential elements in the test mode of operation, unloading the bits of the first result vector of bits into the chain of sequential elements. Among the potential benefits, rather than assuming that an integrated circuit has not been compromised, the integrated circuit performs self-validation to prove that the integrated circuit is trustworthy.

In accordance with example implementations, providing the first input vector of bits includes a deterministic random bit generator of the integrated circuit generating the first input vector. Among the potential benefits, random vectors have no input data set, thereby avoiding the relatively large data set used by ATPG; and rather than assuming that a hardware trust anchor has not been compromised, the hardware trust anchor performs self-validation to prove that the trust anchor is trustworthy.

In accordance with example implementations, measuring the integrated circuit includes providing an input vector to an automatic test pattern generation infrastructure of the integrated circuit, and receiving a result vector corresponding to the hardware integrity measurement from the automatic test pattern generation infrastructure. Among the potential benefits, rather than assuming that an integrated circuit has not been compromised, the integrated circuit performs self-validation to prove that the integrated circuit is trustworthy.

In accordance with example implementations, the validation includes applying a cryptographic hash algorithm to an input derived from the initial portion of the firmware image and the hardware integrity measurement to provide an observed hash; reading an expected hash from a one-time-programmable (OTP) memory of the integrated circuit; and comparing the observed hash to the expected hash. Among the potential benefits, the use of hashes avoids storing and processing large datasets corresponding to the hashes; and rather than assuming that a hardware trust anchor has not been compromised, the hardware trust anchor performs self-validation to prove that the trust anchor is trustworthy.

In accordance with example implementations, the observed hash is associated with a measurement digest for the computer platform, which is produced by a measured boot of the computer platform. Among the potential benefits, a hardware trust anchor-derived measurement digest for a computer platform may be used to verify whether the computer platform is trustworthy.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
measuring, by a self-validation engine of an integrated circuit, the integrated circuit to provide a hardware integrity measurement;
generating, by the self-validation engine, an observed fingerprint for the integrated circuit based on the hardware integrity measurement and a firmware integrity measurement; and
validating, by the self-validation engine, the integrated circuit based on the observed fingerprint.

2. The method of claim 1, wherein:
the self-validation engine comprises a trust anchor of a computer platform;
the firmware integrity measurement comprises an initial portion of a firmware image; and
the initial portion of the firmware image corresponds to an initial link of a chain of trust for the computer platform.

3. The method of claim 2, further comprising:
regulating a boot of the computer platform responsive to a result of the validation.

4. The method of claim 1, wherein:
the observed fingerprint comprises an observed hash;
generating the observed fingerprint comprises applying, by the self-validation engine, a cryptographic hash algorithm to an input to provide the observed hash, wherein the input comprises the hardware integrity measurement and the firmware integrity measurement; and
validating the integrated circuit comprises comparing, by the self-validation engine, the observed hash to an expected hash.

5. The method of claim 1, wherein measuring the integrated circuit comprises measuring combinatorial logic of the integrated circuit.

6. The method of claim 5, wherein measuring the combinatorial logic comprises:
providing a first input vector of bits to combinatorial logic cones of the integrated circuit; and
responsive to providing the first input vector of bits to the combinatorial logic cones, receiving a first result vector of bits from the combinatorial logic cones, wherein the hardware integrity measurement comprises the first result vector of bits.

7. The method of claim 6, wherein the measuring the combinatorial logic further comprises:
providing a second input vector of bits to the combinatorial logic cones;
responsive to providing the second input vector of bits to the combinatorial logic cones, receiving a second result vector of bits from the combinatorial logic cones; and
combining the first result vector of bits and the second result vector of bits to provide the hardware integrity measurement.

8. The method of claim 6, wherein:
the combinatorial logic cones are connected to a chain of sequential elements; and
providing the first input vector of bits to the combinatorial logic cones comprises:
placing the chain of sequential elements in a test mode of operation; and
responsive to placing the chain of sequential elements in the test mode of operation, loading the bits of the first input vector of bits into the chain of sequential elements.

9. The method of claim 8, further comprising:
transitioning the chain of sequential elements from the test mode of operation to a production mode of operation to cause the chain of sequential elements to capture a response of the combinatorial logic cones to the first input vector of bits.

10. The method of claim 9, wherein receiving the first result vector of bits comprises:
transitioning the chain of sequential elements from the production mode of operation to the test mode of operation; and
responsive to placing the chain of sequential elements in the test mode of operation, unloading the bits of the first result vector of bits into the chain of sequential elements.

11. The method of claim 1, wherein measuring the integrated circuit comprises:
providing an input vector to an automatic test pattern generation infrastructure of the integrated circuit; and
receiving a result vector corresponding to the hardware integrity measurement from the automatic test pattern generation infrastructure.

12. A computer platform comprising:
a main processor;
a memory to store a firmware image; and
a management controller comprising a hardware-based root of trust engine, wherein the hardware-based root of trust engine corresponds to a trust anchor for a chain of trust for the computer platform, and the hardware-based root of trust engine to:
measure a part of the firmware image corresponding to an initial link of the chain of trust to provide a first integrity measurement;
combine the first integrity measurement and a second integrity measurement of the hardware-based root of trust engine to determine an observed integrity measurement; and
validate the hardware-based root of trust engine and the part of the firmware image based on the observed integrity measurement.

13. The computer platform of claim 12, wherein:
the management controller comprises a hardware processing core; and
the hardware-based root of trust engine to further:
responsive to power being provided to the management controller, hold the hardware processing core in reset; and
release the hardware processing core from the reset in response to a result of the validation.

14. The computer platform of claim 12, wherein:
the management controller comprises a hardware processing core and a memory; and
the hardware-based root of trust engine to further:
concurrently with the validation, load the part of the firmware image into the memory of the management controller; and
lock the memory of the management controller to prevent content from the part of the firmware image from being modified after the content is loaded into the memory of the management controller.

15. The computer platform of claim 12, wherein the hardware-based root of trust engine to further prevent the computer platform from booting in response to the validation failing.

16. The computer platform of claim 12, wherein:
the hardware-based root of trust engine comprises a hash generator to generate a hash corresponding to the observed integrity measurement based on the first integrity measurement and the second integrity measurement; and
the hardware-based root of trust engine to further:
compare the hash corresponding to the observed integrity measurement to an expected hash; and
validate the hardware-based root of trust engine and the part of the firmware instructions based on a result of the comparison.

17. The computer platform of claim 16, further comprising:
one-time-programmable (OTP) fuses configured with a state to represent the expected hash.

18. A baseboard management controller comprising:
a processing core to provide a management service for a computer platform;
an integrated circuit;
a scan chain of the integrated circuit to provide a hardware integrity measurement of the integrated circuit;
a hardware circuit of the integrated circuit corresponding to an anchor of trust for a chain of trust for the computer platform, wherein the hardware circuit to: measure a portion of a firmware image corresponding to an initial link of the chain of trust to provide a firmware integrity measurement; and
combine the firmware integrity measurement and the hardware integrity measurement to provide an observed hash.

19. The baseboard management controller of claim 18, wherein the observed hash is associated with a measurement digest for the computer platform produced by a measured boot of the computer platform.

20. The baseboard management controller of claim 18, wherein the hardware circuit to further:
compare the observed hash to an expected hash; and
regulate a trusted boot of the computer platform responsive to a result of the comparison.
